(19) United States
(12) Patent Application Publication
(10) Pub. No.: US 2016/0161635 A1
(43) Pub. Date: Jun. 9, 2016

(54) A SIMULATION-TO-SEISMIC WORKFLOW CONSTRUED FROM CORE BASED ROCK TYPING AND ENHANCED BY ROCK REPLACEMENT MODELING

(71) Applicant: LANDMARK GRAPHICS CORPORATION, Houston, TX (US)

(72) Inventors: Travis St. George RAMSAY, Rosenberg, TX (US); Jeffrey Marc YARUS, Houston, TX (US)

(21) Appl. No.: 14/893,929

(22) PCT Filed: Aug. 13, 2013
(86) PCT No.: PCT/US2013/054752

§ 371 Date: Nov. 24, 2015

(51) Int. Cl. G01V 99/00; G06F 17/10

(52) U.S. Cl. CPC G01V 99/005; G06F 17/10

(57) ABSTRACT

The disclosed embodiments include a system and method for performing a simulation to seismic process. In one embodiment, the system is configured to perform operations comprising constructing a petrophysical realization and selecting a candidate model for fluid flow simulation using the petrophysical realization. Empirical petrofacies definitions is applied on the selected candidate model and assigning relative permeability at each node of the petrofacies definitions of the selected candidate model. The operations performs flow simulation on selected candidate model and performs analysis on the results of the simulation on selected candidate model to verify rock type flow units. The dynamic and static simulation results are synthesized such that the combined data yield a measurable rock property that may be compared to seismic properties and used to calibrate subsequent iterations of the static earth model. The continued iteration of the workflow may then be undertaken with the updated/refined earth model.

### BACKGROUND OF THE INVENTION

1. Field of the Invention

The present invention generally relates to the field of computerized reservoir flow modeling, and more particularly, to a system and method configured for verifying rock type flow units from flow simulation.

2. Discussion of the Related Art

Seismic to simulation is the process and associated techniques used to develop highly accurate static and dynamic 3D models of hydrocarbon reservoirs for use in predicting future production, placing additional wells, and evaluating alternative reservoir management scenarios. Seismic to simulation enables the quantitative integration of all field data into an updateable reservoir model built by a team of geologists, geophysicists, and engineers. Key techniques used in the process include integrated petrophysics and rock physics to determine the range of lithotypes and rock properties, geostatistical inversion to determine a set of plausible seismic-derived rock property models at sufficient vertical resolution and heterogeneity for flow simulation, stratigraphic grid transfer to accurately move seismic-derived data to the geologic model, and flow simulation for model validation and ranking to determine the model that best fits all the data. This process is successful if the model accurately reflects the original well logs, seismic data and production history. However, seismic to simulation is not always successful as seismic data may be inaccurate, incomplete, or all together not available.

Accordingly, the disclosed embodiments propose that a petrophysical model with or without the influence of geologic facies be used to identify rock type flow units through flow simulation, which may then be used to guide the spatial (geometric) interpretation of geologic facies or rock types through a closed loop workflow (i.e., simulation to seismic). As a result, one gains information about static properties from dynamic simulation and their relationship to flow units.

### BRIEF DESCRIPTION OF THE DRAWINGS

Illustrative embodiments of the present invention are described in detail below with reference to the attached drawing figures, which are incorporated by reference herein and wherein:

FIG. 1 illustrates an example of a traditional earth modeling workflow in accordance with the disclosed embodiments;

FIG. 2 illustrates an example of the traditional earth modeling workflow with a simulation to seismic component in accordance with the disclosed embodiments;

FIG. 3 illustrates an example of a probability plot in accordance with the disclosed embodiments;

FIG. 4 illustrates an example of a cross plot used for defining petrofacies in accordance with the disclosed embodiments;

FIG. 5 illustrates an example of an interface depicting a comparison of four different facies model in accordance with the disclosed embodiments;

FIG. 6 illustrates an example of four relative permeability curves in accordance with the disclosed embodiments;

FIG. 7 illustrates an example of a result/validation interface in accordance with the disclosed embodiments;

FIG. 8 illustrates an example of an oil production rate plot in accordance with the disclosed embodiments;

FIG. 9 illustrates an example of a cumulative oil production plot in accordance with the disclosed embodiments; and

FIG. 10 is a block diagram illustrating one embodiment of a system for implementing the disclosed embodiments.

### DETAILED DESCRIPTION

The disclosed embodiments include a system and method for determining rock types/rock type flow units from flow simulation. As referenced herein a flow unit is a stratigraphically continuous interval of similar reservoir process speed that maintains the geologic framework and characteristics of rock types. Rock types are units of rock deposited under similar conditions which experienced similar diagenetic processes resulting in a unique porosity-permeability relationship, capillary pressure profile and water saturation for a given height above free water in a reservoir.

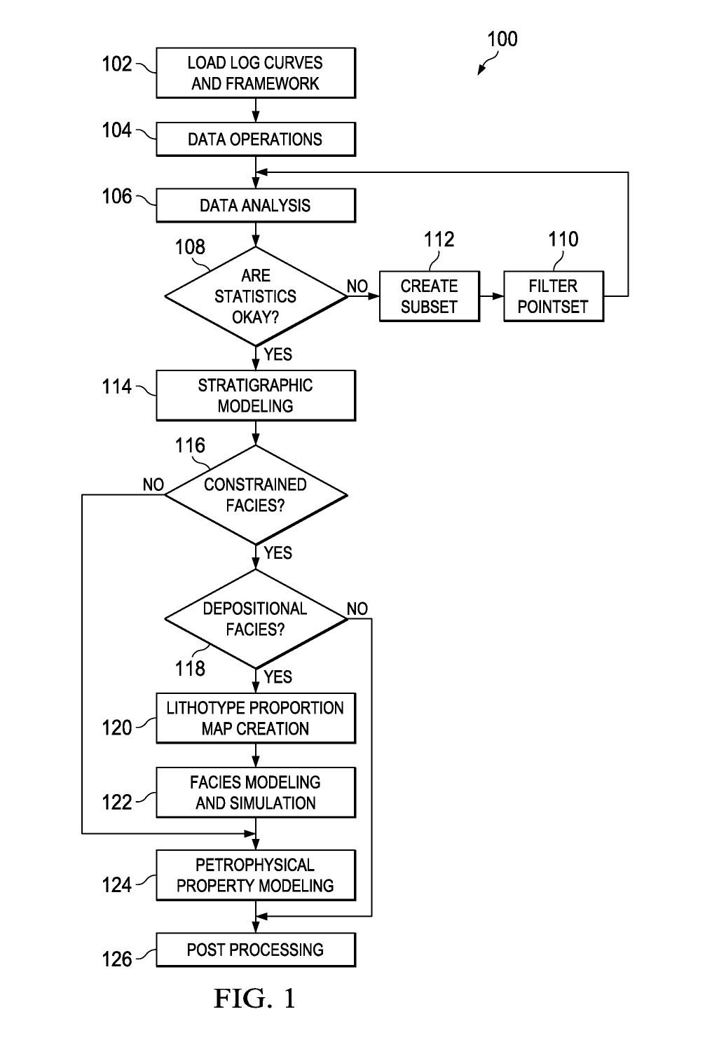

The disclosed embodiments and advantages thereof are best understood by referring to FIGS. 1-10 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 illustrates an example of a traditional earth modeling workflow 100 in accordance with the disclosed embodiments. The depicted process may be implemented using software such as, but not limited to, DecisionSpace® Earth Modeling software available from Landmark Graphics Corporation. DecisionSpace® Earth Model delivers 2D and 3D earth modeling and visualization technologies for reservoir to basin-scale projects. The technology includes state-of-the-art data analysis, stratigraphic gridding, facies and petrophysical property modeling and probabilistic uncertainty analysis to deliver simulation-ready models.

The earth modeling workflow 100 involves the construction of a petrophysical model, which is spatially constrained by defined facies. A facies is a body of rock with specified characteristics. These facies are usually derived from examination of petrophysical and rock physics based relationships observed in well logs or geophysical logs (step 102). The petrophysical model are employed to help reservoir engineers and geoscientists understand the rock properties of the reservoir, particularly how pores in the subsurface are interconnected, controlling the accumulation and migration of hydrocarbons.

As shown in the depicted earth modeling workflow 100, after the well log and a selected framework is loaded and analyzed (steps 104-112), the earth modeling workflow 100 performs stratigraphic modeling (step 114). Stratigraphic modeling includes creating a grid that is used to model the sub-horizontal surfaces and seams. As part of the process, in certain embodiments, a user may specify the layering style, number of layers, or thickness within each interval for stratigraphic modeling. A user may also alter the size and areal extent of the selected framework and adjust the rotation of the framework.

After stratigraphic modeling, the earth modeling workflow 100 includes steps for constraining the model with respect to depositional facies (step 118). This includes creating a lithotye proportion map (i.e., a vertical proportion matrix) (step 120). The lithotye proportion map consists of lithology curves representing the facies proportions lithotypes (grouped facies) locally for every blocked layer throughout the model. The purpose of the lithotye proportion map is to introduce secondary information, e.g., various trends, in the data to enable better control over facies boundary conditions.

The lithotye proportion map is used as input for facies modeling and simulation (step 122). This step involves simulating facies onto the grid. The object is to create a high-resolution definition of the vertical and lateral facies relationship within each stratigraphic reservoir interval. Multiple facies simulations could be computed using stochastic simulation methods.

After facies modeling and simulation are completed, petrophysical property modeling (step 124) is used to populate the facies models with petrophysical properties (porosity, permeability, water saturation, etc.). The petrophysical property modeling is configured to enable users to construct multiple realizations of distributed petrophysical properties at any level of detail including by individual facies and by individual interval. Additionally, in accordance with the disclosed embodiments, petrophysical property modeling may also be performed on models without facies constraints (step 116). Accordingly, this step includes the option to include or not include lithotype constraints. For instance, in one embodiment, if lithotype constraints are not included, petrophysical modeling can be performed inside the stratigraphic grid without using a facies model.

The earth modeling workflow 100 further includes post processing analysis (step 126). For example, in accordance with the disclosed embodiments, probabilistic uncertainty analysis may be performed using all the multiple realizations of facies and petrophysical properties allowing the user to select any quantile or set of quantiles to be used for subsequent analysis like flow simulation. Probability maps may be generated and visualized for thresholds defined by any quantile or for a range of quantiles. Further, stochastic volumetric calculations can be derived generating a variety of useful metrics such as pore volume, original hydrocarbons in place, and recoverable hydrocarbons. Calculations can support oil-water, gas-water, and gas-oil-water contacts, as well as saturations above contacts.

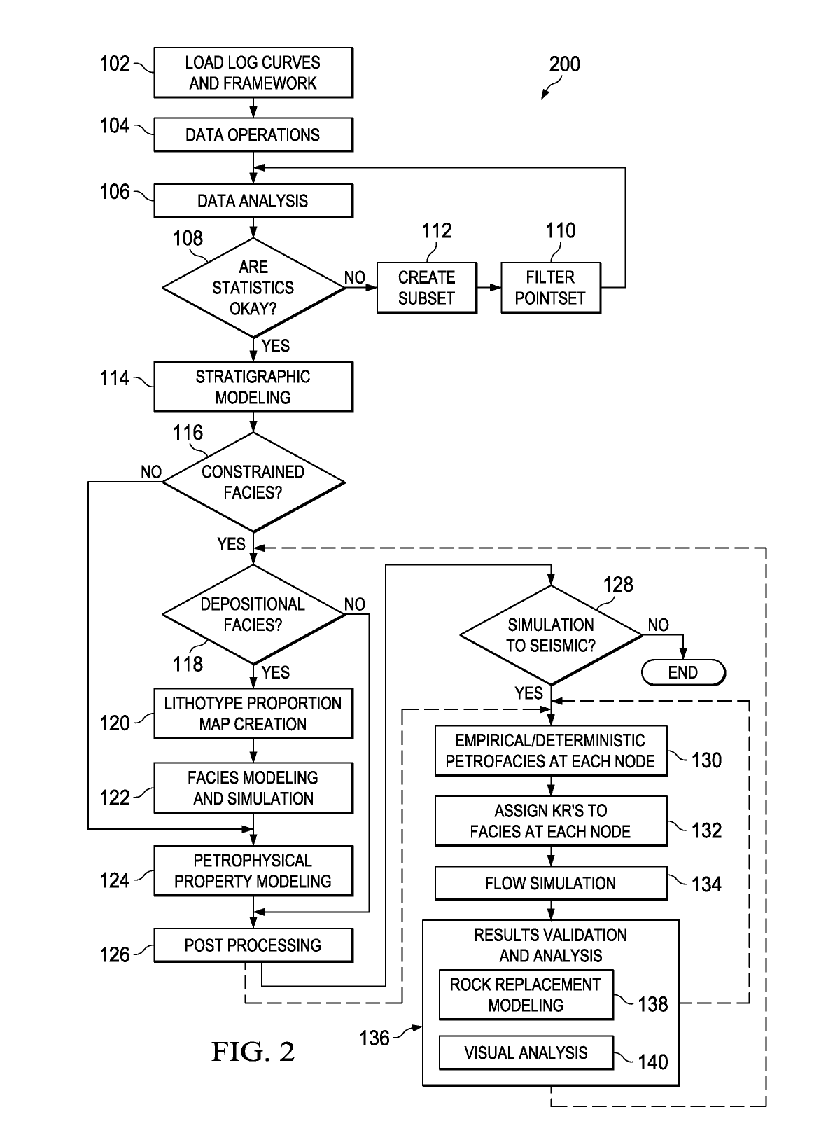

FIG. 2 illustrates an example of a modified earth modeling workflow 200 with a simulation to seismic component (steps 128-140) in accordance with the disclosed embodiments. In the depicted embodiment, following post processing, the simulation to seismic component provides a feedback loop of the simulation results that may be used to validate against seismic data. As shown in the modified earth modeling workflow 200, the simulation to seismic component may be performed on models that are constrained with respect to depositional facies and those that are unconstrained with respect to depositional facies.

If simulation to seismic is enabled (step 128), the modified earth modeling workflow 200 proceeds to use empirical or deterministic petrofacies definition at each node (step 130). For instance, in one embodiment, rock mechanical and petrophysical rock properties are measured in physical or digital laboratories, outside of the numerical modeling environment, such that relative permeability, capillary pressure, bulk modulus, and shear modulus are obtained. A corollary of the direct core measurements performed in the laboratory is the definition of rock types based on analysis of petrographic, mechanical and petrophysical properties, which may be classified according to ranges of porosity/permeability relationships.

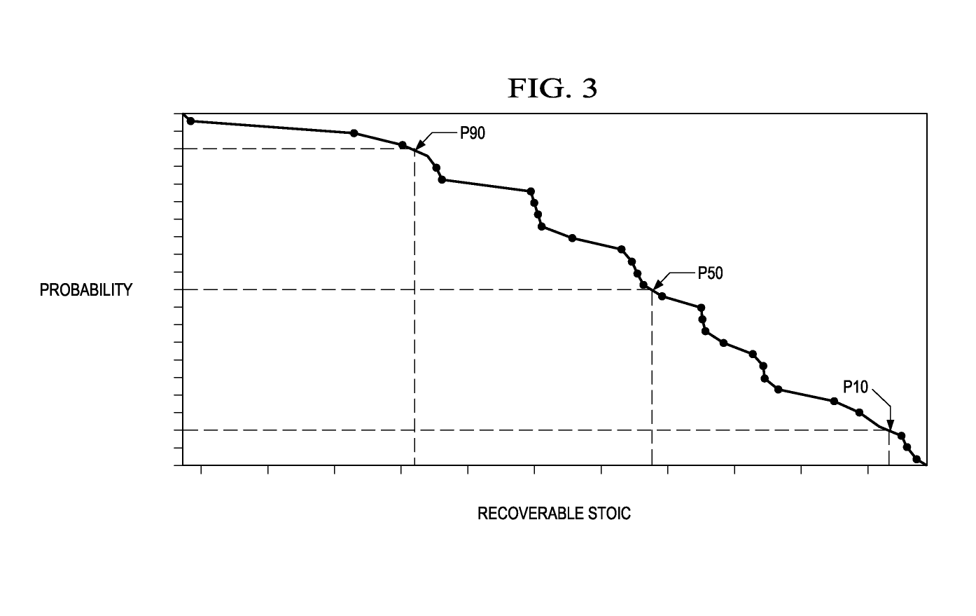

For example, in one embodiment, after defining a grid or subset of grid and performing facies modeling (step 122) and petrophysical modeling (step 124) to determine realization of porosity, the modified earth modeling workflow 200 performs post-processing analysis (step 126), which includes generating a probability plot, as illustrated in FIG. 3 in which probability is on the y-axis and recoverable stoic is on the x-axis, to enable identification of the most likely realization to conduct the simulation to seismic process. The petrophysical realizations may be ranked volumetrically to determine a P10, P50 and P90 candidates for fluid flow simulation. P90 refers to proved reserves, P50 refers to proved and probable reserves and P10 refers to proved, probable and possible reserves. In one embodiment, the process may be configured to automatically select one of the rankings for performing fluid flow simulation. For example, the process may be configured to automatically select the P50 candidate for each of the models (models that are constrained with respect to facies and the models that are unconstrained with respect to facies) for performing fluid flow simulation.

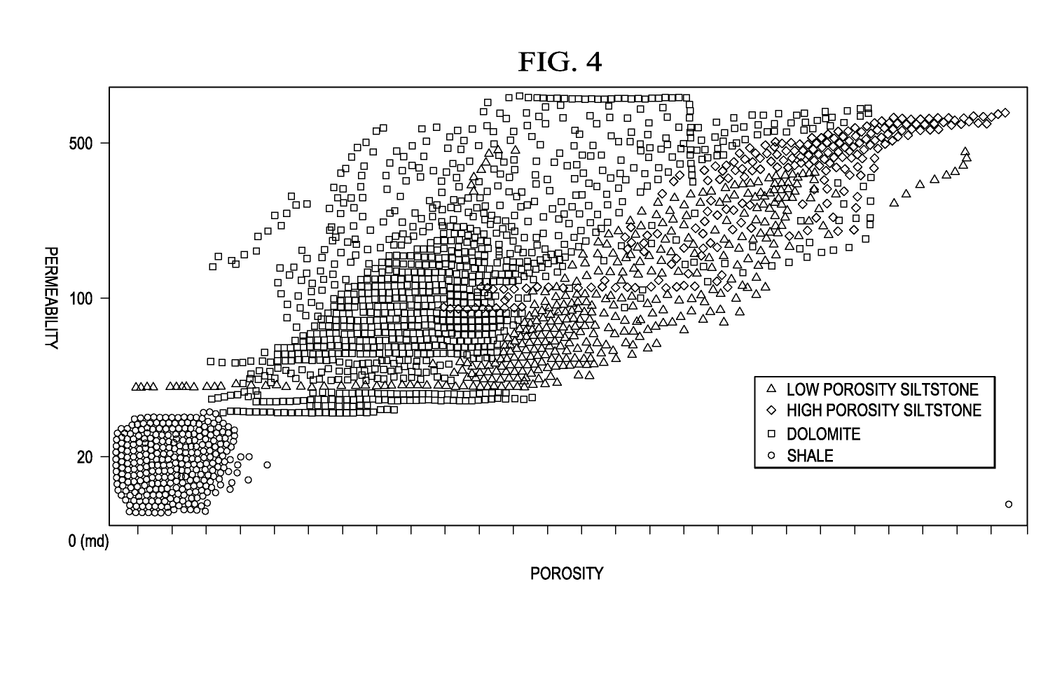

After post-processing, the process utilizes empirical relations for determining actual petrofacies definition (step 130). As an example, FIG. 4 illustrates a cross plot 400 that may be used for defining petrofacies in accordance with the disclosed embodiments. The cross plot 400 plots permeability on the y-axis and porosity on the x-axis, and includes four different facies as indicated by the four different shapes. For example, in one embodiment, the circles represent shale, the diamonds represent high porosity siltstone, the triangles represent low porosity siltstone, and the squares represent dolomite. The process is configured to apply a rigid permeability cutoff to define the four petrofacies. For example, in one embodiment, based on concentration, shale is determined to have a permeability cutoff at a lower bound of 0 millidarcy (md) and an upper bound of 20 md, low porosity siltstone is determined to have a permeability cutoff between 20 md and 100 md, dolomite is determined to have a permeability cutoff between of 100 md to 500 md, and high porosity siltstone is determined to have a permeability cutoff between 500 md and above.

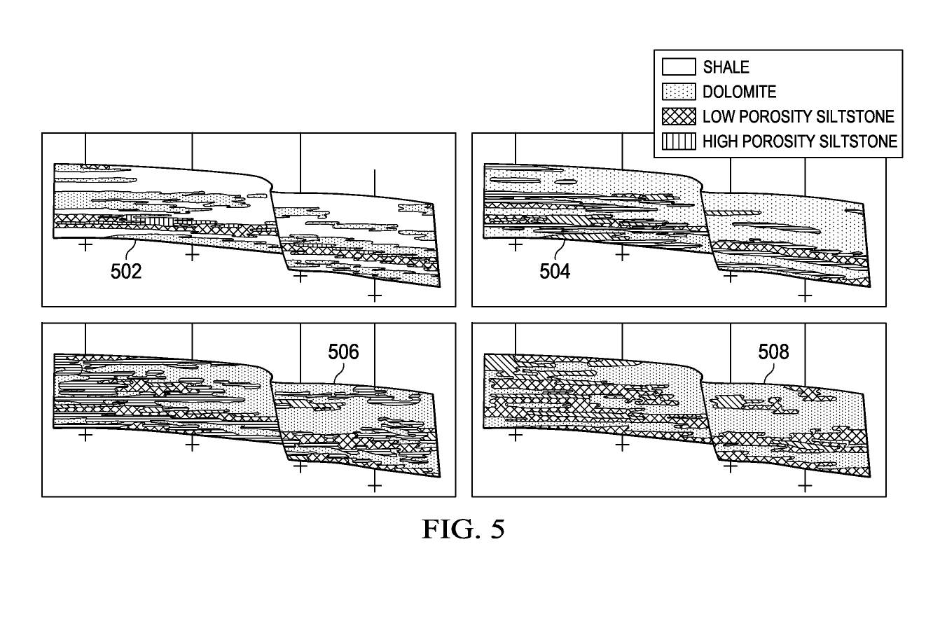

Once the process determines the different interface ranges based on permeability, the process applies them to the selected models/volumes to derive volumes of petrofacies. As an example, FIG. 5 illustrates an interface depicting a comparison of four different facies models/volumes with the applied permeability cutoffs in accordance with the disclosed embodiments. Volume 502 illustrates a traditional depositional facies model with four different facies that are consistent with available seismic data. Volumes 504, 506, and 508 illustrate petrophysical models that are constrained and unconstrained with respect to depositional facies, but are still constrained with respect to seismic. In particular, volume 504 illustrates a petrophysical model that is constrained with respect to depositional facies with the applied permeability cutoffs. Volumes 506 and 508 illustrate petrophysical models that are unconstrained with respect to depositional facies with the applied permeability cutoffs. Volume 506 illustrates all four petrofacies types (shale, low porosity siltstone, high porosity siltstone, and dolomite), whereas volume 508 illustrates only three petrofacies type in which low porosity siltstone and dolomite, based on their overlap, are combined into one petrofacies type due to these rock types having similar flow properties on macro scale.

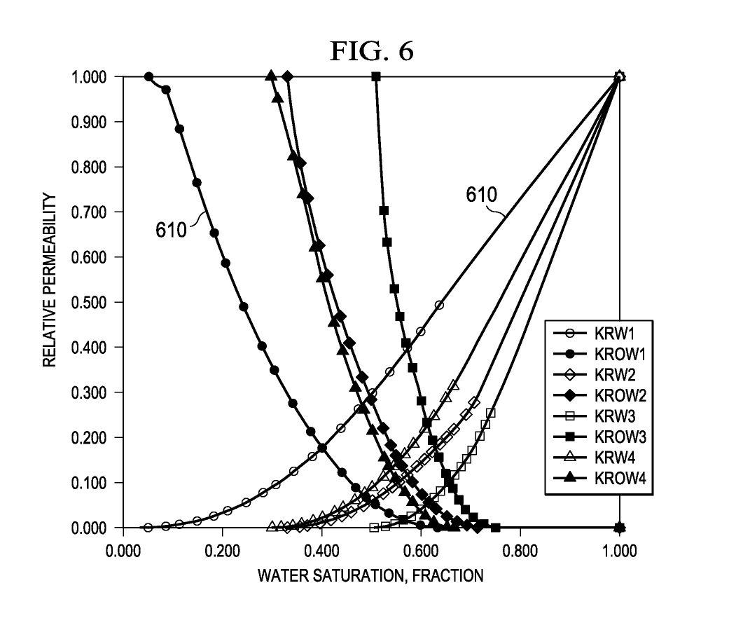

Following the above step, the process assigns relative permeability curves at a geo-cellular level to each of the petrofacies definition, thus, defining petrofacies with respect to permeability. An example of four relative permeability curves describing the water-oil system corresponding to the four identified depositional facies is illustrated in FIG. 6. The relative permeability curves depict rock-fluid and fluid-fluid interaction. For example, the relative permeability curves 610 indicate low water retention on the residual and high associated velocity in terms of where it intersects the remaining permeability curves. In some embodiments, capillary pressure curves, if available, may also be assigned to individual grid cells of selected candidate.

Once the relatively permeability curves are assigned at a geo-cellular level to the petrofacies definition, then at cellular level, the process assigns relative permeability to each node/cell according to the petrofacies definition (step 132). Relative permeability defines the rock-fluid and the fluid-fluid interaction that occurs in the reservoir.

The process then performs flow simulation (step 134) using flow simulation software such as, but not limited to, Nexus® reservoir simulation software available from Landmark Graphics Corporation. In certain embodiments, the process may receive certain parameters for performing the flow simulation such as, but not limited to, fluid reservoir constants, water properties, stock tank density, formation volume factors and viscosities, standard conditions, and equilibrium data. Additionally, certain geomechanical characteristics of the porous media may be omitted, inferred, or assumed. For example, the process may infer rock type classification if rock deformation is included.

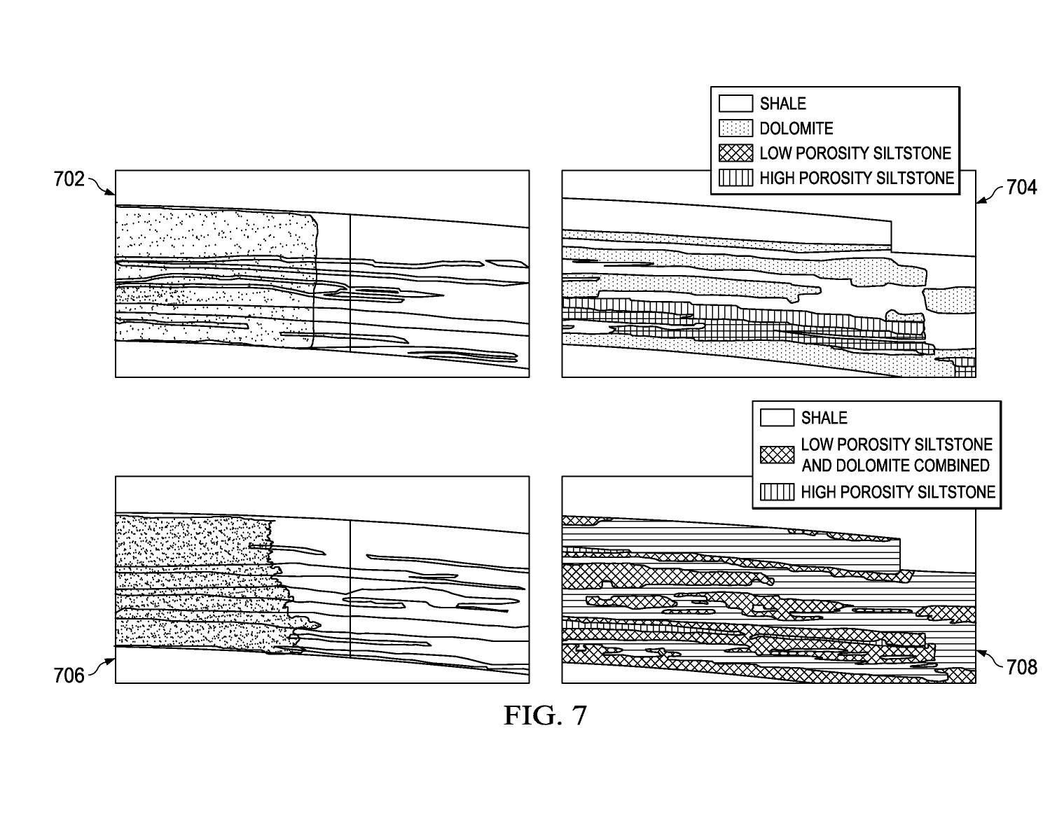

Once flow simulation is complete, results validation and analysis may be performed (step 136). As an example, FIG. 7 illustrates a result/validation interface 700 in accordance with the disclosed embodiments. Images 702 and 706 of the result/validation interface 700 depicts seismic that is underneath saturation results for the two different cases shown in the corresponding images 704 and 708 on the right hand side of the result/validation interface 700. Image 704 depicts the four depositional facies assignment as described above, whereas image 708 depicts the scenario in which only three depositional facies are utilized as described above. Image 702 illustrates a snapshot of the generated flow simulation results considering depositional faces as a constraint, which were further constrained by the determined petrofacies definition. In contrast, image 706 illustrates the generated flow simulation results corresponding to petrofacies definitions that were unconstrained with respect to depositional facies. As can be seen from the image 702, as the simulation progresses through time, there are areas that the flow will travel through quicker, which corresponds to facies definition in images 704. Thus, the fluid front is honoring the geometry of the depositional facies, so the depositional facies maintain a geometric constraint. Image 706, as previously stated, represents the results corresponding to petrofacies definitions that were unconstrained with respect to depositional facies. There, the fluid front is a bit more jagged than the constrained model (image 702) and there is an implication of increased tortuosity in this system because the permeability is a bit more sporadic in their occurrence, a lot less definition, and as a result, the flow deviates due to the quick change in relative permeability assignment on a cell by cell level.

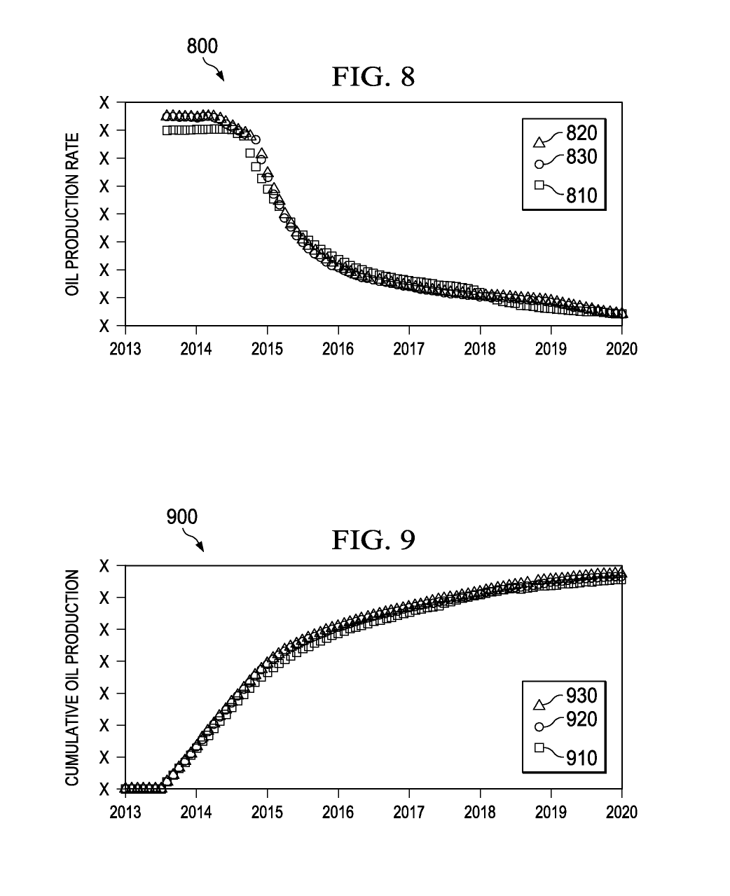

The process can further be configured to analyze/validate simulation production profiles. For example, FIG. 8 illustrates an example of an oil production rate plot 800 corresponding to the above example. The oil production rate plot 800 graphs oil production rate on the y-axis against time in years on x-axis. The oil production rate plot 800 depicts three oil production rates that correspond to different scenarios. For example, the curve 810 corresponds to a model that is constrained with respect to depositional facies. As shown, during the first few years (2013-2015), oil production is rather stable. Following this period, it converges with the curve 820 and curve 830, and there is a decrease in production rate. Curve 820 and curve 830 correspond to models that are unconstrained with respect to depositional facies, but instead use the determined petrofacies definitions with the permeability cutoffs for assigning relative permeability. As depicted, during the same time period (2013-2015) where there is a more stable production rate under the constrained model (curve 810), the production rate of the unconstrained models are undulating. This undulation in production is expected because the pressure field would not have developed as easily or as quickly in a scenario where the fluids are more dispersed due to where and how relative permeabilities with very hard permeability cutoffs are being applied at such discrete numerical values of permeability. Thus, curve 820 and curve 830 are rather undulating and more perturbed as expected with dispersed flow in a more dispersed medium having interchanging fluid properties due to the relative permeability assignments. However, after 7 years of production as the production plots approach the year 2020 in the simulation, curve 820 and curve 830 converge with respect to the initial model (curve 810), which had a depositional facies constraint.

The process may further be configured to validate the simulated cumulative oil production results as illustrated in a cumulative oil production plot 900 shown in FIG. 9. The cumulative oil production plot 900 graphs cumulative oil production on the y-axis against time in years on the x-axis. Curve 910 corresponds to a model that is constrained with respect to depositional facies. Curve 920 represents an unconstrained model with respect to depositional facies having three defined petrofacies types, whereas the curve 930 represents an unconstrained model with respect to depositional facies having four defined petrofacies types. The cumulative oil production plot 900 indicates that for this particular model, the simulation could have used the unconstrained model with respect to depositional facies having only three defined petrofacies types (curve 920) as opposed to using the using unconstrained model with respect to depositional facies having four defined petrofacies types (curve 930) because the curve 920 more closely matches the model that is constrained with respect to depositional facies (curve 910). Thus, in certain embodiments, the process could be further optimized by omitting one or more depositional faces definitions.

Additionally, as depicted in the cumulative oil production plot 900, the process further validates that in the event that a model that is constrained with respect to depositional facies is unavailable for this data set, as represented by curve 910, the determined petrofacies definitions could be used, as represented by curve 920 and curve 930, due to the similarities in the simulated cumulative oil production results after seven simulated years in production.

With reference back to FIG. 2, in one embodiment, the modified earth modeling workflow 200 is configured to perform rock replacement modeling 138 as part of the results validation and analysis process 136. During the step, the process uses the prior knowledge of laboratory derived petrophysical relationships in combination with the visualized flow field to identify Rock types as flow units based on preferential, segregated or isolated (no flow) regimes, at varying degrees. The interpretation of reservoir scale rock type flow units entails the inference of stratification from flow. The construed workflow also permits the creation of rock property volumes as an inverse modeling approach. Because the effects of porous media stratification on relative permeability is known; the relative permeability curves, as described above, generated as a result of laboratory experiments on cores with established Rock types would have qualitative and quantitative characteristics associated with multiphase flow. These characteristics are demonstrated to be consequences of layering in the porous media. Thus, analogous to performing fluid replacement modeling to predict rock physics attributes, the disclosed embodiments may be configured to use “rock replacement modeling” to produce rock property volumes from computed saturation profiles. For instance, given the saturation profiles, as well as knowledge of the matrix, water and hydrocarbon densities, the Wyllie density of the saturated rock volume may be computed as follows:

ρₛₐₜ=ρₘₐₜᵣᵢₓ(1−φ)+ρ_{w}S_{w}φ+ρ_{hc}(1−S_{w})φ

The Wyllie density of the saturated rock volume may then be input into the Biot-Gassman equations to obtain Vp (compressional wave velocity) and Vs (shear wave velocity)

$${V}_{p} = \sqrt{\frac{{K}_{sat} + \frac{4}{3} {µ}_{sat}}{{ρ}_{sat}}}$$

$${V}_{s} = \sqrt{\frac{{µ}_{sat}}{{ρ}_{sat}}}$$

along with the saturated bulk modulus (Kₛₐₜ) and the saturated shear modulus (μₛₐₜ); which is equivalent to the shear modulus of dry rock (μ_{dry}) since it is well understood that shear waves are not affected by pore fluid-s-waves cannot be propagated through fluids.

This leads to time-dependent volumes of Vp and Vs being created which allows volumes of P-Impedance (PI)

PI=ρV

where (ρ) is density and (V) is seismic velocity as well as Poisson's Ratio

$$σ = \frac{1}{2} \frac{( {V}_{p}^{2} - 2 {V}_{s}^{2} )}{( {V}_{p}^{2} - {V}_{s}^{2} )}$$

to be created. Use of a crossplot to enhance the analysis of these individual recurrent data volumes (P-impedance-Poisson's Ratio-Gamma Ray, P-impedance-Vp/Vs-Gamma Ray, P-Impedance-Vp/Vs-density or others) would permit the quantification of facies groups from time-dependent rock property volumes constructed after flow simulation which would be verified through a direct comparison of static acoustic impedance to dynamically derived acoustic impedance obtained from the simulation to seismic process using a rock replacement model.

In the absence of rock replacement modeling 138, the dynamic simulation results may be validated with respect to static acoustic impedance volume derived from seismic through visual analysis 140 of dynamic saturation profile with respect to static acoustic impedance. The petro-facies definitions may be altered by the user such that the dynamic fluid simulation is more coincident with the structural and conductive properties of the acoustic impedance constraint or the depositional facies model is redefined so that the static model yields a dynamic simulation which is a better match to production history.

Additionally, whether performing rock replacement modeling 138 or visual analysis 140, in both embodiments, the results validation and analysis step 136 may be modified based on the minimization of the relative difference between production history and the simulations obtained from the simulation to seismic workflow. A subsequent iteration of facies modeling and simulation (indicated by the dash lines shown in FIG. 2) may be undertaken if a depositional facies model exists (step 118). In the absence of a depositional facies model, a subsequent iteration of the empirical petro-facies definitions/assignments (step 130) may be performed in order to more accurately define the hydraulic flow units within the reservoir volume; and as an iterative process re-execute the simulation with which the results may be verified against seismic acoustic impedance. The aforementioned subsequent iterations of the workflow may be performed until the static earth model yields a dynamic simulation having a better match to production history.

Whether in the presence of or in the absence of crossplot analysis of rock property volumes the Rock type may be identified along an existing well trace or a new well trace may be interpreted (a pseudo well) that allows a rock type log to be created. This is achieved by creating a Rock type property volume based on petrophysical cutoffs. The Rock type log would be constructed of unique interpreted index values of Rock type intersected by the well trace. Once created, and calibrated with respect to seismic acoustic impedance, it may then be incorporated into a subsequent iteration of building an earth model which would involve using the Rock type modeling, as opposed to facies modeling, to constrain the spatial (geometric) propagation of petrophysical properties in the petrophysical modeling process according to observed bulk flow.

Thus, the disclosed embodiments provide a process for utilizing reservoir simulation results within the context of earth modeling and seismic (acoustic impedance) calibration (i.e., simulation to seismic). Advantages of the disclosed embodiments include enabling contextualizing of flow simulation results back to the underlying seismic and facies related constraints as well as identify where changes could be made to an initial interpretation of flow units as petrofacies in the earth modeling workflow, while maintaining consistency with seismic data. In addition, the disclosed embodiments do not require interpreted facies to constrain the spatial distribution of petrophysical properties in the static earth model. Any existing rock physics models or seismic inversion volumes may be used to compare or assist in the definition of rock types.

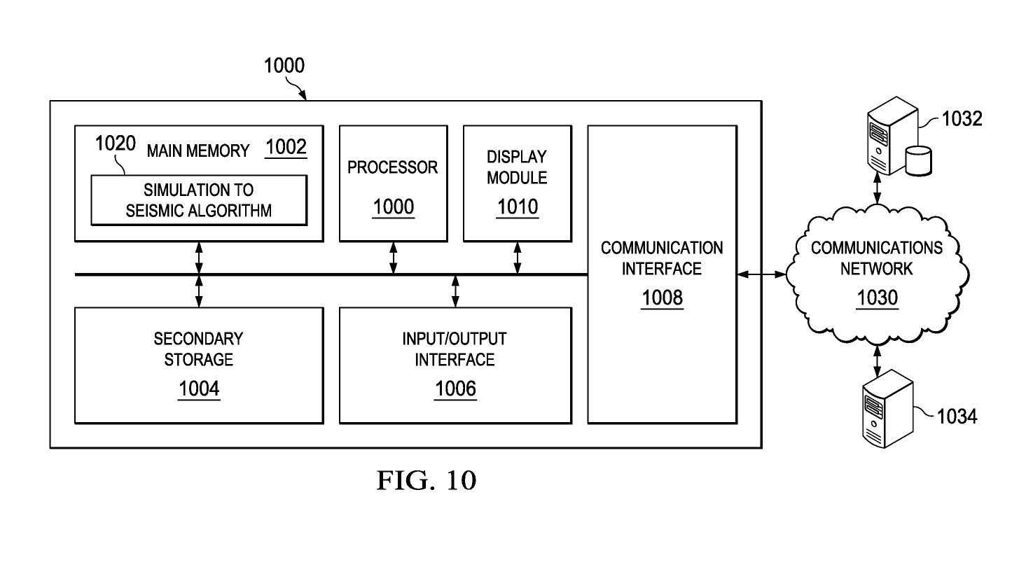

FIG. 10 is a block diagram illustrating one embodiment of a system 1000 for implementing the features and functions of the disclosed embodiments. The system 1000 includes, among other components, a processor 1000, main memory 1002, secondary storage unit 1004, an input/output interface module 1006, and a communication interface module 1008. The processor 1000 may be any type or any number of single core or multi-core processors capable of executing instructions for performing the features and functions of the disclosed embodiments.

The input/output interface module 1006 enables the system 1000 to receive user input (e.g., from a keyboard and mouse) and output information to one or more devices such as, but not limited to, printers, external data storage devices, and audio speakers. The system 1000 may optionally include a separate display module 1010 to enable information to be displayed on an integrated or external display device. For instance, the display module 1010 may include instructions or hardware (e.g., a graphics card or chip) for providing enhanced graphics, touchscreen, and/or multi-touch functionalities associated with one or more display devices.

Main memory 1002 is volatile memory that stores currently executing instructions/data or instructions/data that are prefetched for execution. The secondary storage unit 1004 is non-volatile memory for storing persistent data. The secondary storage unit 1004 may be or include any type of data storage component such as a hard drive, a flash drive, or a memory card. In one embodiment, the secondary storage unit 1004 stores the computer executable code/instructions and other relevant data for enabling a user to perform the features and functions of the disclosed embodiments.

For example, in accordance with the disclosed embodiments, the secondary storage unit 1004 may permanently store the executable code/instructions of the above-described simulation to seismic algorithm 1020. The instructions associated with the simulation to seismic algorithm 1020 are then loaded from the secondary storage unit 1004 to main memory 1002 during execution by the processor 1000 for performing the disclosed embodiments.

The communication interface module 1008 enables the system 1000 to communicate with the communications network 1030. For example, the network interface module 1008 may include a network interface card and/or a wireless transceiver for enabling the system 1000 to send and receive data through the communications network 1030 and/or directly with other devices.

The communications network 1030 may be any type of network including a combination of one or more of the following networks: a wide area network, a local area network, one or more private networks, the Internet, a telephone network such as the public switched telephone network (PSTN), one or more cellular networks, and wireless data networks. The communications network 1030 may include a plurality of network nodes (not depicted) such as routers, network access points/gateways, switches, DNS servers, proxy servers, and other network nodes for assisting in routing of data/communications between devices.

For example, in one embodiment, the system 1000 may interact with one or more servers 1034 or databases 1032 for performing the features of the present invention. For instance, the system 1000 may query the database 1032 for well log information for deriving petrophysical and rock physics based relationships in accordance with the disclosed embodiments. In one embodiment, the database 1032 may utilize OpenWorks® software to effectively manage, access, and analyze a broad range of oilfield project data in a single database. Further, in certain embodiments, the system 1000 may act as a server system for one or more client devices or a peer system for peer to peer communications or parallel processing with one or more devices/computing systems (e.g., clusters, grids).

While specific details about the above embodiments have been described, the above hardware and software descriptions are intended merely as example embodiments and are not intended to limit the structure or implementation of the disclosed embodiments. For instance, although many other internal components of the system 1000 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming

Additionally, the flowchart and block diagrams in the figures illustrate the architecture, functionality, and operation of possible implementations of systems, methods and computer program products according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In summary, the disclosed embodiments include a method, apparatus, and computer program product for verifying rock type flow units using flow simulation. For example, one embodiment is a computer-implemented method that includes the steps of constructing a petrophysical realization and selecting a candidate model for fluid flow simulation using the petrophysical realization. In certain embodiments, the petrophysical realization is constrained with respect to depositional facies derived from analyzing well logs, whereas alternatively in certain embodiments, the petrophysical realization is unconstrained with respect to depositional facies. In one embodiment, in selecting the candidate for fluid flow simulation using the petrophysical realization, the process performs a ranking of the petrophysical realizations volumetrically to determine a P10, P50 and P90 realization. In some embodiments, the process may be configured to automatically select the P50 realization as the candidate for fluid flow simulation.

The computer-implemented method also includes applying empirical petrofacies definitions on the selected candidate model and assigning relative permeability at each node of the petrofacies definitions of the selected candidate model. In one embodiment, the process applies a rigid permeability cutoff to define the petrofacies definitions. The process may further include assigning relative permeability curves at a geo-cellular level to each of the petrofacies definitions. Once the process completes assigning relative permeability at each node of the petrofacies definitions of the selected candidate model, the process performs flow modeling simulation on selected candidate model. The computer-implemented method performs analysis on the results of the flow modeling simulation to identify rock types. In certain embodiments, the analysis may include analyzing simulated oil production rates and simulated cumulative oil production results and/or may also include validating a combined static and dynamic model with respect to acoustic impedance.

In another embodiment, a non-transitory computer readable medium comprising computer executable instructions for verfiying rock type flow units using flow simulation is provided. The computer executable instructions when executed causes one or more machines to perform operations comprising constructing a petrophysical realization and selecting a candidate model for fluid flow simulation using the petrophysical realization. The computer executable instructions further includes instructions for applying empirical petrofacies definitions on the selected candidate model and assigning relative permeability at each node of the petrofacies definitions of the selected candidate model. Finally, the computer executable instructions further includes instructions for performing flow modeling simulation on selected candidate model and performing analysis on the results of the simulation on selected candidate model to identify rock types. In certain embodiments, the above instructions may be performed on a petrophysical realization that is constrained with respect to depositional facies derived from analyzing well logs and/or may be performed on a petrophysical realization that is unconstrained with respect to depositional facies.

In addition, in certain embodiments, the computer executable instructions may further include instructions for ranking the petrophysical realizations to determine a P10, P50 and P90 realization and automatically selecting one of the petrophysical realizations that is most likely to occur. In defining the petrofacies definitions, in one embodiment, the computer executable instructions include instructions for applying a rigid permeability cutoff The computer executable instructions may further include instructions for assigning relative permeability curves at a geo-cellular level to each of the petrofacies definitions. Still, in certain embodiments, in performing analysis on the results of the simulation on selected candidate model, the computer executable instructions may further include instructions for analyzing simulated oil production rates and simulated cumulative oil production results and/or validate a combined static and dynamic model with respect to acoustic impedance.

Another embodiment of the disclosed inventions is a system that includes at least one processor and at least one memory coupled to the at least one processor and storing instructions that when executed by the at least one processor performs operations comprising constructing a petrophysical realization and selecting a candidate model for fluid flow simulation using the petrophysical realization. The operations further include applying empirical petrofacies definitions on the selected candidate model and assigning relative permeability at each node of the petrofacies definitions of the selected candidate model. The operations performs flow modeling simulation on selected candidate model and performs analysis on the results of the simulation on selected candidate model to identify rock types.

In certain embodiments, additional operations performed the system may include ranking the petrophysical realizations volumetrically to determine a P10, P50 and P90 realization and automatically selecting one of the petrophysical realizations that is most likely to occur. In one embodiment, the operations performed by the system may include applying a rigid permeability cutoff in defining the petrofacies definitions. In certain embodiments, the operations performed by the system may further include assigning relative permeability curves at a geo-cellular level to each of the petrofacies definitions. Still, in some embodiments, in performing analysis on the results of the simulation on selected candidate model, the system may be configured to perform analysis on simulated oil production rates and simulated cumulative oil production results. In certain embodiments, in performing analysis on the results of the simulation on selected candidate model, the system may also be configured to validate a combined static and dynamic model with respect to acoustic impedance.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to explain the principles of the invention and the practical application, and to enable others of ordinary skill in the art to understand the invention for various embodiments with various modifications as are suited to the particular use contemplated. The scope of the claims is intended to broadly cover the disclosed embodiments and any such modification.

1. A computer-implemented method for verfiying rock type flow units from flow simulation, the method comprising:
constructing a petrophysical realization;
selecting a candidate model for fluid flow simulation using the petrophysical realization;
applying empirical petrofacies definitions on the selected candidate model;
assigning relative permeability at each node of the petrofacies definitions of the selected candidate model;
performing flow simulation on selected candidate model; and
analyzing results of the flow simulation on selected candidate model to verify rock type flow units.

2. The computer-implemented method of claim 1, wherein the petrophysical realization is constrained with respect to depositional facies derived from analyzing well logs.

3. The computer-implemented method of claim 1, wherein the petrophysical realization is unconstrained with respect to depositional facies.

4. The computer-implemented method of claim 1, wherein selecting the candidate for fluid flow simulation using the petrophysical realization comprises ranking petrophysical realizations volumetrically to determine a P10, a P50 and a P90 realization, and selecting the P50 realization as the candidate for fluid flow simulation.

5. The computer-implemented method of claim 1, further comprising assigning relative permeability curves at a geo-cellular level to each of the petrofacies definitions.

6. The computer-implemented method of claim 1, further comprising:
combining fluid distributions from dynamic simulation with known rock properties;
determining the flow simulation driven density and acoustic impedance property for calibration with respect to an original seismic acoustic impedance;
optimizing a static earth model with a spatial depositional facies constraint that leverages static and dynamic simulation results.

7. The computer-implemented method of claim 1, wherein analyzing the results of the simulation on selected candidate model to identify rock types includes validating a combined static and dynamic model with respect to acoustic impedance.

8. A non-transitory computer readable medium comprising computer executable instructions for verfiying rock type flow units using flow simulation, the computer executable instructions when executed causes one or more machines to perform operations comprising:
constructing a petrophysical realization;
selecting a candidate model for fluid flow simulation using the petrophysical realization;
applying empirical petrofacies definitions on the selected candidate model;
assigning relative permeability at each node of the petrofacies definitions of the selected candidate model;
performing flow simulation on selected candidate model; and
analyzing results of the flow simulation on selected candidate model to verfiying rock type flow units.

9. The computer readable medium of claim 8, wherein the petrophysical realization is constrained with respect to depositional facies derived from analyzing well logs.

10. The computer readable medium of claim 8, wherein the petrophysical realization is unconstrained with respect to depositional facies.

11. The computer readable medium of claim 8, wherein selecting the candidate for fluid flow simulation using the petrophysical realization comprises ranking petrophysical realizations volumetrically to determine a P10, a P50 and a P90 realization, and selecting the P50 realization as the candidate for fluid flow simulation.

12. The computer readable medium of claim 8, further comprising assigning relative permeability curves at a geo-cellular level to each of the petrofacies definitions.

13. The computer readable medium of claim 8, further comprising applying a rigid permeability cutoff to define the petrofacies definitions.

14. A system, comprising:
at least one processor; and
at least one memory coupled to the at least one processor and storing instructions that when executed by the at least one processor performs operations comprising:
constructing a petrophysical realization;
selecting a candidate model for fluid flow simulation using the petrophysical realization;
applying empirical petrofacies definitions on the selected candidate model;
assigning relative permeability at each node of the petrofacies definitions of the selected candidate model;
performing flow simulation on selected candidate model; and
analyzing results of the flow simulation on selected candidate model to identify rock types.

15. The system of claim 14, wherein the petrophysical realization is constrained with respect to depositional facies derived from analyzing well logs.

16. The system of claim 14, wherein the petrophysical realization is unconstrained with respect to depositional facies.

17. The system of claim 14, wherein selecting the candidate for fluid flow simulation using the petrophysical realization comprises ranking petrophysical realizations volumetrically to determine a P10, a P50 and a P90 realization, and selecting the P50 realization as the candidate for fluid flow simulation.

18. The system of claim 14, further comprising computer executable instructions for assigning relative permeability curves at a geo-cellular level to each of the petrofacies definitions

19. The system of claim 14, further comprising computer executable instructions for applying a rigid permeability cutoff to define the petrofacies definitions.

20. The system of claim 14, wherein analyzing the results of the simulation on selected candidate model to identify rock types includes analyzing simulated oil production rates and simulated cumulative oil production results.
